(19) United States
(12) Patent Application Publication
(10) Pub. No.: US 2026/0104052 A1
(43) Pub. Date: Apr. 16, 2026

(54) SYSTEMS AND METHODS FOR OPERATING A DEVICE USING A VARIABLE SPEED PUMPING TIMER

(71) Applicant: Pentair, Inc., Minneapolis, MN (US)

(72) Inventors: James Miller, Sanford, NC (US); Kevin Harms, Clayton, NC (US)

(21) Appl. No.: 19/116,044

(22) PCT Filed: Oct. 2, 2023
(86) PCT No.: PCT/US2023/075752

§ 371 Date: Mar. 27, 2025

Related U.S. Application Data
(60) Provisional application No. 63/377,980, filed on Sep. 30, 2022.

(51) Int. Cl. F04D 15/00

(52) U.S. Cl. CPC F04D 15/0066

(57) ABSTRACT

Systems and methods are provided to operate one or more devices by a variable speed pumping timer. In one embodiment, the variable speed pumping timer operates the one or more devices through a pump. In another embodiment, the variable speed pumping timer operates a first device through a pump and directly operates a second device without using the pump. In yet another embodiment, the variable speed pumping timer directly operates the one or more devices without using a pump. After the variable speed pumping timer operates the one or more devices, the pump and the one or more devices remain connected to a power source and thus, remain functional.

### CROSS-REFERENCE TO RELATED APPLICATIONS

This Application claims priority to U.S. Provisional Patent Application Ser. No. 63/377,980, filed on Sep. 30, 2022, entitled “SYSTEMS AND METHODS FOR OPERATING A DEVICE USING A SMART TIMER,” currently pending, the entire disclosure of which is incorporated herein by reference.

### TECHNICAL FIELD

The present disclosure generally relates to variable speed pumping timer controller systems and methods of using the same. More particularly, the present disclosure relates to systems and methods of operating one or more devices through the use of a variable speed pumping timer.

### BACKGROUND

Spring wound timers including wall-mounted timers have long been used to operate pumps and other electrical devices. By using a spring wound timer, a user can set a time period during which the pump and/or the electrical devices can be turned on or operated. Spring wound timers may be connected to a power source. A user twists the spring wound timer to set it for a desired time period. The twisting by the user winds a spring in the spring wound timer, which in turn closes an electrical circuit. Once the electrical circuit is closed, power can pass through the spring wound timer and on to the device that is connected to the spring wound timer. The set time period expires when the spring completely unwinds, thereby mechanically opening the electrical circuit.

This kind of arrangement for connecting a pump and other electrical devices with a spring wound timer uses a high-voltage relay or a contactor to disconnect the power from the pump and the electrical device. Thereby, the pump and electrical device are effectively turned off.

Existing spring wound timers are outdated and have several shortcomings. For example, once the pump and the electrical devices are no longer turned on due to disconnection of the power, the pump and the electrical devices are also disabled and are unable to connect with any communication networks. In this situation, the pump and the electrical devices are not able to receive any information from the network. Further, in order to enable the pump and the electrical devices to receive any information or updates over the network, the user has to physically turn the spring wound timer. This makes remote operation from off-site impossible. Further, cycling the power on and off to the pump through the use of the spring wound timer contributes to the wear and tear of a variable speed motor control and reduces its life. Similarly, this power cycling adds wear and tear to the electrical components of the electrical devices.

Therefore, there is a need for a system and method to operate one or more devices for desired periods of time without disconnecting the devices from a power source.

### SUMMARY

A system for operating one or more devices is provided. The system comprises a variable speed pumping timer, a pump, and one or more devices. Further, the variable speed pumping timer is configured to receive an input from a user to operate the one or more devices and transmit a control signal to the pump in response to the input. Also, the pump is connected to a power source and configured to receive the control signal from the variable speed pumping timer and operate the one or more devices based on the control signal, with the pump remaining connected to power after operating the one or more devices.

A method for operating one or more devices is also provided. The method comprises the steps of receiving an input from a user to operate one or more devices via a variable speed pumping timer, and transmitting a control signal to a pump to operate the one or more devices in response to the input received from the user. The pump is connected to a power source and remains connected after operating the device.

A system for operating one or more devices is provided. The system comprises a power source, a variable speed pumping timer, a pump, and one or more devices. Further, the variable speed pumping timer is configured to receive an input from a user to operate a first device and transmit a first control signal to the pump to operate the first device in response to the user input. Also, the variable speed pumping timer is configured to identify a second device and transmit a second control signal to the second device to operate the second device in response to the first device. Further, the pump is connected to the power source and is configured to receive the first control signal from the variable speed pumping timer. The pump is also configured to operate the first device based on the first control signal received from the variable speed pumping timer. Also, the second device is connected to the power source and the pump remains connected to the power source after operating the first device. Further, the second device remains connected to the power source after the second device is operated by the variable speed pumping timer.

A method for operating one or more devices is provided. The method comprises the steps of receiving an input from a user to operate a first device via a variable speed pumping timer, transmitting a first control signal to a pump for operating the first device in response to the input received from the user, and identifying a second device and transmitting a second control signal to the second device to operate the second device in response to the first device. Further, the pump and the second device are connected to a power source. The pump remains connected to the power source after operating the first device and the second device remains connected to the power source after the second device is operated by the variable speed pumping timer.

A variable speed pumping timer for operating one or more devices is provided. The variable speed pumping timer includes an interface configured to receive an input from a user to operate one or more devices. Further, the variable speed pumping timer comprises a transceiver configured to transmit a control signal to operate the one or more devices in response to the input received from the user, wherein each of the one or more devices is connected to a power source and remains connected to the power source after the one or more devices is operated by the variable speed pumping timer.

A method for operating one or more devices is provided. The method comprises the step of receiving an input from a user to operate one or more devices via a variable speed pumping timer. The method also comprises the step of transmitting a control signal to operate the one or more devices in response to the input received from the user. Each of the one or more devices is connected to a power source and remains connected to the power source after the one or more devices is operated by the variable speed pumping timer.

In some embodiments, the pump is further configured to receive information from a network after operating the one or more devices.

In some embodiments, the information received from the network corresponds to an update related to one or more devices.

In some embodiments, the user input corresponds to a time period for operating the one or more devices.

In some embodiments, the one or more devices is operated by turning on the one or more devices.

In some embodiments, the one or more devices comprises a blower, an auxiliary blower, one or more lights, a brush, a scrubber, a valve, a pump, and/or a heater.

In some embodiments, the control signal corresponds to a wireless signal, a wired signal, or a combination of wired and wireless signals.

In some embodiments, the pump corresponds to a variable speed pump.

In some embodiments, the variable speed pumping timer, the pump, and/or the one or more devices are Wi-Fi enabled.

In some embodiments, the variable speed pumping timer, the pump, and/or the one or more devices are connected through a wired connection.

In some embodiments, the pump is further configured to receive information from the network after operating the first device, and the second device is further configured to receive information from the network after the second device is operated by the variable speed pumping timer.

In some embodiments, the one or more devices is further configured to receive information from a network after the one or more devices is operated by the variable speed pumping timer.

In some embodiments, the second device is intended to be operated simultaneously with the first device.

In some embodiments, the variable speed pumping timer transmits the first control signal and the second control signal via one or more of a wired connection and a wireless connection.

In some embodiments, the variable speeding pumping timer is powered by the power source.

In some embodiments, the variable speed pumping timer remains connected to the power source after operating the second device.

In some embodiments, the variable speed pumping timer includes a processor configured to identify the first device based on the input received from the user and identify a second device based on the first device.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is a schematic diagram of a first system architecture including a variable speed pumping timer in communication with one or more devices through a pump according to the principles of this disclosure;

FIG. 2 is a side isometric view of the pump of FIG. 1;

FIG. 3 is an exploded side isometric view of the pump of FIG. 1;

FIG. 4 is a first partial top plan view of the pump of FIG. 1 with some parts removed for clarity;

FIG. 5 is a second partial top isometric view of the pump of FIG. 1 with some parts removed for clarity;

FIG. 6 is an exploded isometric view of an IO expansion module of the pump of FIG. 1;

FIG. 7 is a block diagram of the variable speed pumping timer of FIG. 1;

FIG. 8 is a flow diagram depicting a first method for operating at least one device within the first system architecture of FIG. 1 according to the principles of this disclosure;

FIG. 9 is a schematic diagram of a second system architecture including a variable speed pumping timer connected with one or more devices directly and connected with one or more devices via a pump according to the principles of this disclosure;

FIG. 10 is a flow diagram depicting a second method for operating at least one device within the second system architecture of FIG. 9 according to the principles of this disclosure;

FIG. 11 is a schematic diagram of a third system architecture including a variable speed pumping timer connected with one or more devices, according to the principles of this disclosure; and

FIG. 12 is a flow diagram depicting a method for operating at least one device within the third system architecture of FIG. 11 according to the principles of this disclosure.

### DETAILED DESCRIPTION

Before any embodiments are explained in detail, it is to be understood that this disclosure is not limited in its application to the details of construction and the arrangement of components set forth in the following description or illustrated in the following drawings. The system and methods disclosed herein are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the systems and methods described herein. Various modifications to the illustrated embodiments will be readily apparent to those skilled in the art, and the generic principles herein can be applied to other embodiments and applications without departing from the principles of this disclosure. Thus, embodiments disclosed herein are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of this disclosure.

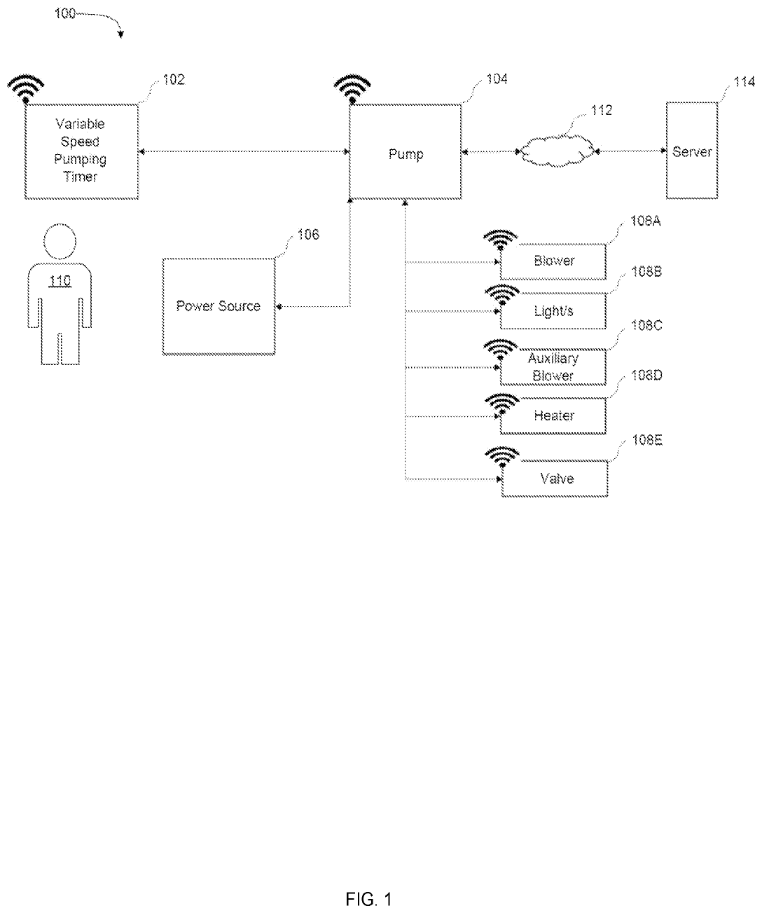

Referring to FIG. 1, a first system architecture 100 is shown depicting a variable speed pumping timer 102 connected with a pump 104, which is in turn further connected with one or more devices 108A-108E, according to an exemplary first embodiment. Thus, the variable speed pumping timer 102 is connected with the one or more devices 108A-108E via the pump 104.

Referring still to FIG. 1, in some embodiments, the variable speed pumping timer 102 may be used by a user to input a time period for operating one or more of the devices 108A-108E. Additionally, in some embodiments, to operate the devices 108A-108E, the variable speed pumping timer 102 transmits control signal/s to the pump 104 and/or the devices 108A-108E. The variable speed pumping timer 102 may be capable of communicating with the one or more devices 108A-108E through the pump 104 or directly with the one or more devices 108A-108E.

The pump 104 may be a variable speed pump or a single speed pump. Further, the one or more devices 108A-108E may be any type of electronically controllable device. For example, the one or more devices 108A-108E, may include, but are not limited to, a spa device, a pool device, a spa/pool device, an auxiliary blower, a blower, a light, an air conditioner, a brush, a scrubber, a valve, a pump, a heater, etc. Although, a limited number of devices 108A-108E are shown in FIG. 1, it is understood for a person skilled in the art that any other device (e.g., a brush, a scrubber etc.) are also within the scope of this disclosure.

The variable speed pumping timer 102, the pump 104, and the devices 108A-E may be in an operational state and/or a functional state. When the devices 108A-108E are in the operational state, the devices are turned on and are performing their intended operations. When these devices are not in the operational state, the devices are turned off do not perform their intended operations. Additionally, when these devices are in the functional state, the devices are not in use (i.e., turned off and not performing its intended operation) but is still awake and can still be used for other non-operational purposes. A device in the functional state can receive electronic information, communications, inputs, and/or commands.

In some instances, the variable speed pumping timer 102 is functional and receives power to communicate with the pump 104. As illustrated in FIG. 1, the variable speed pumping timer 102 receives power from the pump 104.

The power source 106 is electricity generated from any suitable source connected to the pump 104 (e.g., solar panels, an AC power source, a DC power source, etc.). In certain embodiments, the power source 106 is electricity generated from solar panels connected to the pump 104. In another exemplary embodiment, the power source 106 is an alternating current (AC) power source. In yet another exemplary embodiment, the power source 106 is a direct current (DC) power source.

In operation, a user 110 may provide inputs to the variable speed pumping timer 102 to operate the one or more of devices 108A-108E. In some instances, the inputs correspond to a time period set by the user 110 during which a device 108A-108E is to be operated.

Further in operation, in response to the received inputs, the variable speed pumping timer 102 communicates a control signal to the pump 104. In some embodiments, the variable speed pumping timer 102 and the pump 104 communicate with each other through a wired connection (e.g., a RS-485 wired connection, a universal serial bus (USB) wired connection, a RS-232 wired connection, an Inter-Integrated Circuit (I2C) wired connection). In some embodiments, the variable speed pumping timer 102 and the pump 104 communicate with each other through a wireless connection (e.g., Bluetooth, Wi-Fi, near field communication (NFC), etc.) and/or a cellular wireless connection (e.g., global system for mobile communication (GSM), long term evolution (LTE), LoRa techniques, code division multiple access (CDMA), etc.).

Control signals transmitted from the variable speed pumping timer 102 timer 102 to the pump 104 communicate to the pump 104 that one or more of the devices 108A-108E is to be operated for a time period set by the user 110. For example, when the user 110 provides an input to the variable speed pumping timer 102 to operate a first device 108A (e.g., a blower) for a period of ten minutes, this input is communicated to the pump 104 through a control signal, causing the pump 104 to operate the first device 108A for ten minutes. The pump 104 is connected to the power source 106 to draw power to be functional and operational and to operate the devices 108A-108E.

The pump 104 operates the device 108A-108E based on the control signal received from the variable speed pumping timer 102. When the time period set by the user 110 and communicated through the control signal expires, the pump 104 stops operating and turns off the device 108A-108E. For example, when the pump 104 receives the control signal from the variable speed pumping timer 102, the pump 104 turns on the first device 108A for ten minutes. After those ten minutes, the pump 104 stops operating and turns off the first device 108A. To be functional and operational, the devices 108A-108E are connected to and selectively draw power from the power source 106 and the pump 104.

In some embodiments, the pump 104 and the devices 108A-108E communicate with each other through a wired connection (e.g., a RS-485 wired connection, a universal serial bus (USB) wired connection, a RS-232 wired connection, an Inter-Integrated Circuit (I2C) wired connection, etc.). In some embodiments, the pump 104 and the devices 108A-108E communicate with each other through a wireless connection (e.g., Bluetooth, Wi-Fi, a near field communication (NFC), etc.) and/or a cellular wireless connection (e.g., global system for mobile communication (GSM), long term evolution (LTE), LoRa techniques, or code division multiple access (CDMA), etc.).

Referring still to FIG. 1, a network 112 connects the pump 104 to a server 114. The pump 104 remains functional and receives information (e.g., update/s, user status report/s etc.) from the server 114 through the network 112. Similarly, the devices 108A-108E remain functional and receive information from the server 114 through a network 112.

In some embodiments, when the user 110 provides a plurality of inputs, the variable speed pumping timer 102 transmits a corresponding plurality of control signals to the pump 104 to operate a corresponding plurality of the devices 108A-E simultaneously.

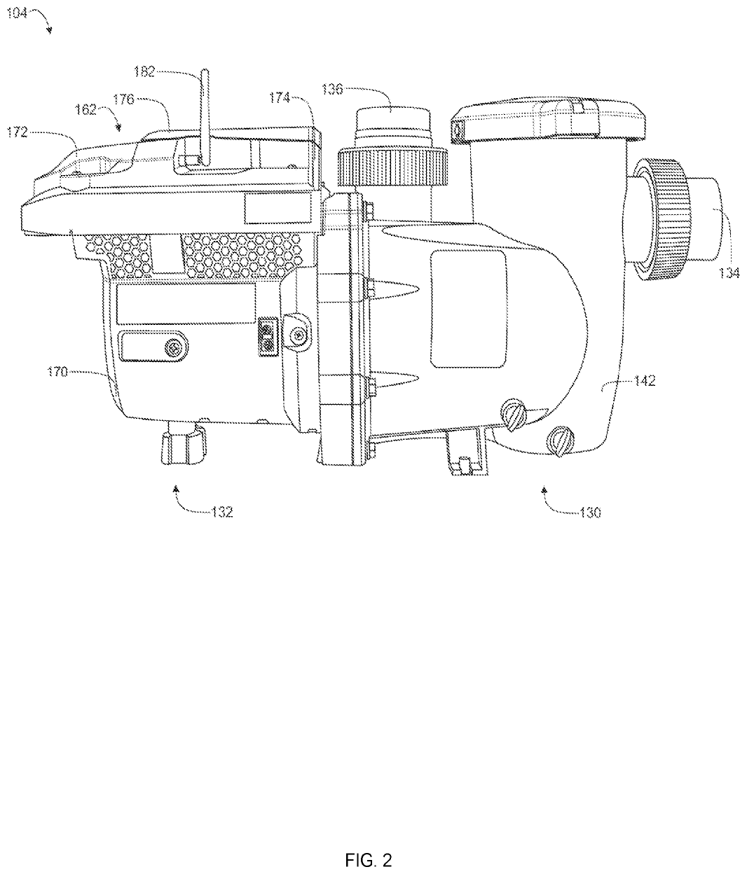

FIG. 2 illustrates the pump 104 according to one embodiment. The pump 104 includes a wet end 130 and a power end 132. The wet end 130 includes an inlet 134 and an outlet 136 that are fluidly coupled to a fluid circuit/pool circulation system of an aquatic application such that water (or another fluid) from the aquatic application can be drawn into the inlet 134 and be pumped out of the outlet 136. In some forms, the pump 104 is installed at a minimum of five feet from the inside wall of the pool, three feet from any heater outlet, and no more than ten feet above the pool water level. In some forms, a 3-inch clearance is provided on the sides and rear of the pump 104 and is secured by two anchor points.

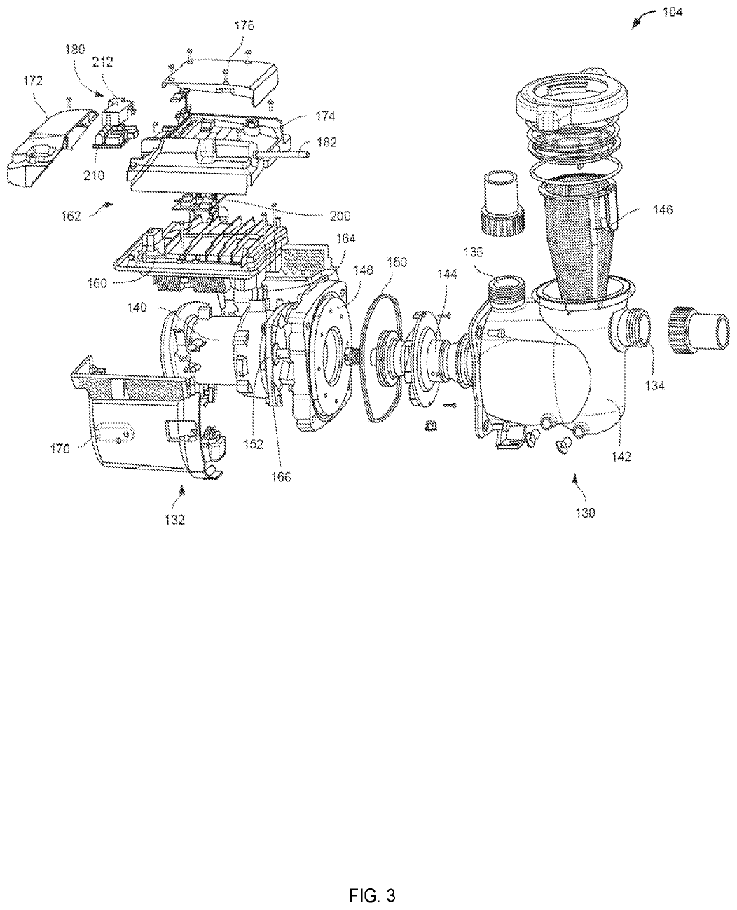

FIG. 3 illustrates additional details and internal components of the pump 104. The power end 132 houses a motor 140, which may be a permanent magnet motor, a synchronous motor, an induction motor, or other motor types known in the art. In some embodiments, the motor 140 is a fully enclosed fan-cooled motor.

The pump 104 is designed to move water through the fluid circuit to and from the aquatic application. In some forms, one or both of the inlet 134 and the outlet 136 include a check valve, e.g., a suction-side check valve and a return/pressure-side check valve, to prevent back flow, to isolate the pump for maintenance, and/or to carry out the preliminary steps of a pump priming process. The wet end 130 contains a volute or strainer pot 142 within which an impeller 144 and a strainer basket 146 are located. The wet end 130 interfaces with the power end 132 via a seal plate 148, which can include an O-ring 150 or other sealing structure to prevent water from seeping out of the pump 104 from the wet end 130. The motor 140 also includes a motor flange 152 that is coupled to the seal plate 148.

The power end 132 includes the motor 140, a variable speed drive 160 provided adjacent and above the motor 140, and an onboard controller 162. In some forms, the motor flange 152 and/or the body of the motor 140 includes a drive connection port 164 through which the motor 140 is electrically connected to the drive 160. As such, the drive 160 is removable and replaceable by disconnecting the drive 160 from the drive connection port 164. The motor 140 includes a drive shaft 166 that extends through the seal plate 148 and is coupled to the impeller 144. Accordingly, the motor 140 produces torque in the drive shaft 166 to rotate the impeller 144, which moves water in through the inlet 134 and out through the outlet 136 of the wet end 130. The variable speed drive 160 is in electrical communication with the onboard controller 162 and the motor 140. In some instances, the variable speed drive 160 provides substantially infinitely variable speed control of the motor 140.

The onboard controller 162 can be coupled to the power end 132 of the pump 104 and can be configured to provide user control of the variable speed drive 160. In some instances, the controller 162 is positionally adjustable with respect to an outer housing of the power end 132. In some instances, the onboard controller 162 includes a USB or other known electrical connection port to which a programming device can be attached to upload or update the software installed on the controller 162. In some other embodiments, the software installed on the controller 162 can be updated via wireless over-the-air updates. The outer housing of the power end 132 can comprise multiple parts. For example, the outer housing can be provided in the form of a motor cover or shroud 170, an end cover 172, a drive cover 174, and a user interface cover 176. The shroud 170 can be provided with various venting arrangements to provide appropriate cooling of the drive 160 and the motor 140. The configuration of the outer housing illustrated in FIG. 3 is not meant to be limiting and can also be provided as a number of other cover piece combinations or as a single integrated part. The drive cover 174 can be sized and shaped to receive an IO expansion module 180 which will be described below. The outer housing can also accommodate an antenna 182. In some forms, the IO expansion module 180 can be removable and mountable to a remote location, such as to a nearby wall, and connected to the onboard controller 162 via a cable providing power, communication capabilities, or both.

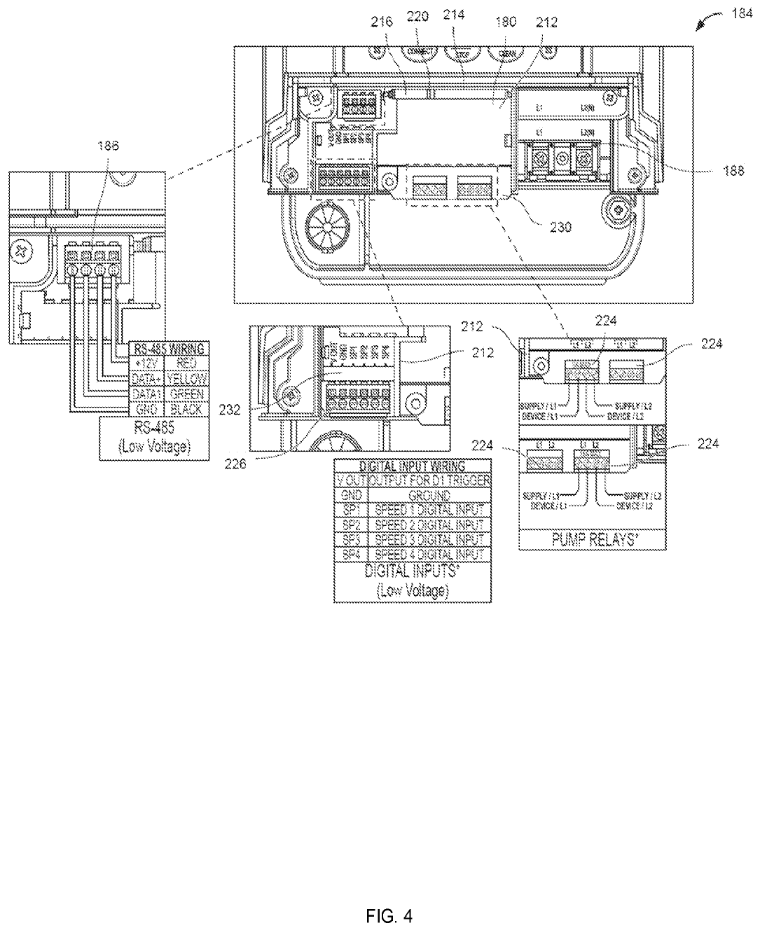

FIG. 4 illustrates an electrical communication assembly 184 for the pump 104. The electrical communication assembly 184 is provided underneath the end cover 172, which protects the electrical communication assembly 184 against physical disturbances and direct contact with liquids, such as rain or pool water. The electrical communication assembly 184 includes the IO expansion module 180, which is an optional and removable feature of the electrical communication assembly 184, an RS-485 terminal block 186, and the main power terminal block 188. The pump 104 can be connected to its own independent GFI-protected circuit.

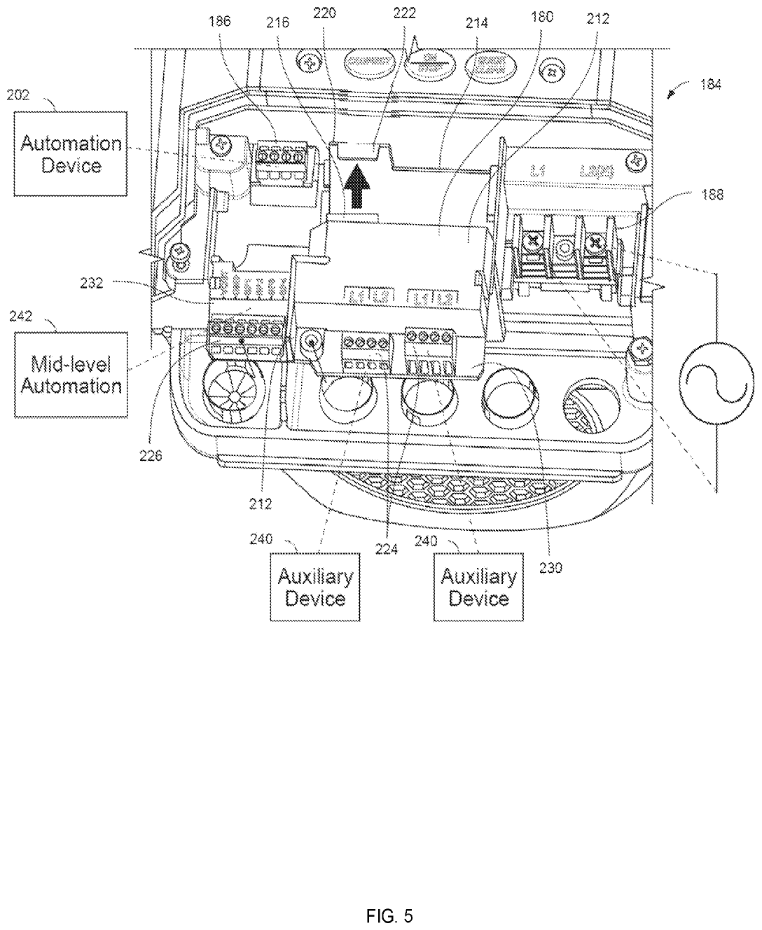

Each of the elements of the electrical communication assembly 184, as well as the antenna 182, are electrically coupled to the onboard controller 162, which includes a main circuit board 200 (see FIG. 3). In some forms, the main circuit board 200 includes a memory unit or a non-transitory computer-readable medium. In some forms, the main circuit board 200 includes a wireless communication unit such as low power system on a chip to provide Wi-Fi and/or Bluetooth capabilities, which will be described further below. The RS-485 terminal block 186 includes the standard wired terminal connections for RS-485 serial communication and can be configured as half-duplex or full duplex communication. The RS-485 terminal block 186 provides the option of electrically coupling an automation device 202 (see FIG. 5) to the pump 104, which allows data to be transmitted to and from the onboard controller 162 and the automation device 202 and allows the automation device 202 to assume control over the pump 104. In some forms, the control can be provided as primary-secondary control in which the pump 104 is secondary to the automation device 202.

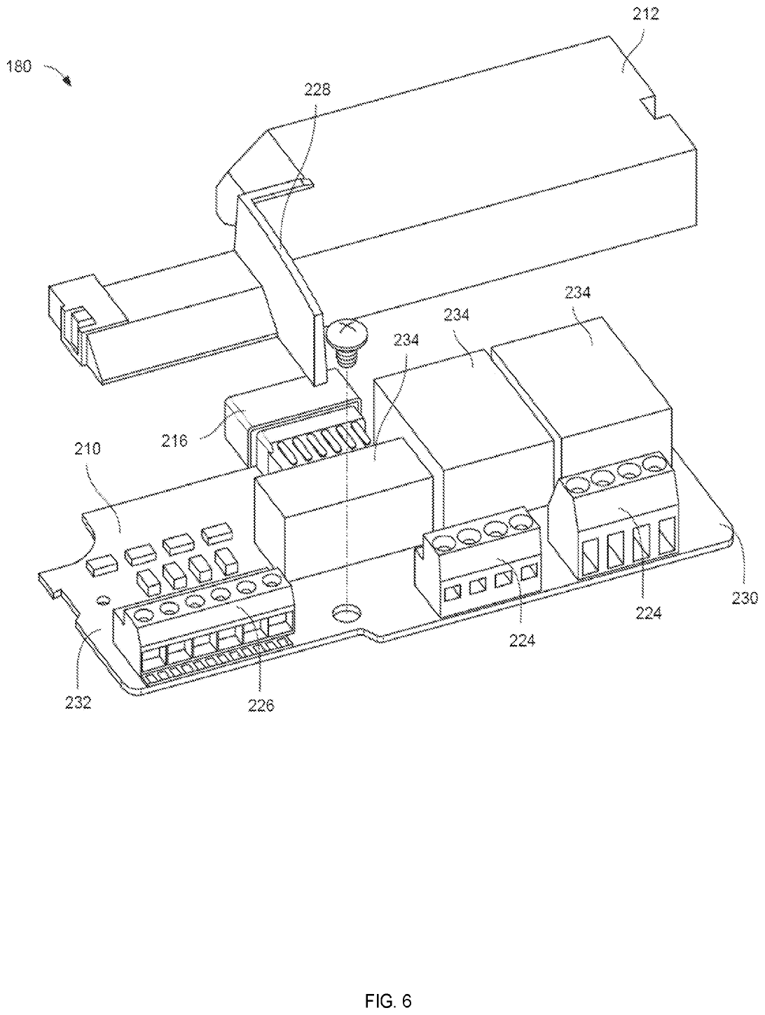

FIGS. 4-6 illustrate the IO expansion module 180 in further detail. In some embodiments, the IO expansion module 180 is defined by a module circuit board 210 (see FIG. 6) and a module cover 212, which in some forms can be selectively coupled and decoupled with the module circuit board 210 e.g., via snap connection. The shape of the cover 212 can be provided as an irregular polyhedron that corresponds to a receptacle 214 provided on the drive cover 174. The main body of the IO expansion module 180 can generally be provided in the form of a rectangular prism, having one or more chamfered edges. On the back side of the IO expansion module 180, an edge connector 216 extends backward to be received within an opening 220 of the drive cover 174. The edge connector 216 mates with, and is electrically coupled to, a male connector 222 of the main circuit board 200 of the electrical communication assembly 184. One or more pump relay terminal blocks 224 and one or more digital input terminals 226 can be provided on the IO expansion module 180, and the pump relay terminal blocks 224 can be separated from the digital input terminals 226 by a divider 228 of the module cover 212. The pump relay terminal blocks 224 can be provided on a front ledge 230 of the module circuit board 210 that extends outward from the front of the IO expansion module 180, and the digital input terminals 226 can be provided on a side ledge 232 of the module circuit board 210. In some forms, when the IO expansion module 180 is installed, at least part of the side ledge 232 extends at least partly underneath the RS-485 terminal block 186. The IO expansion module 180 can be positioned in between the RS-485 terminal block 186 and the main power terminal block 188.

As illustrated in FIGS. 4 and 5, the IO expansion module 180 can be provided in various dimensions suitable for including the pump relay terminals blocks 224, the digital input terminals 226, and the edge connector 216, while also fitting underneath the end cover 172 of the outer housing. As mentioned above, the IO expansion module 180 can provide multiple pump relay terminal blocks 224 and digital input terminals 226. In some instances, one or more relays 234 are electrically coupled to the main circuit board 200 and each of the pump relay terminal blocks 224 to control the delivery of incoming and outgoing 115 VAC or 230 VAC. The relays 234 can be configured to provide the same or different amperage limits, and the relays 234 can be activated at the same time or at different times. For example, one of the relays 234 can provide a higher current limit, and one of the relays 234 can provide a lower current limit. As a non-limiting example, the left-most relay 234 can be rated to provide a maximum of 8 A and the right-most relay 234 can be rated to provide a maximum of 30 A.

In some instances, the left-most relay 234 can be rated to provide a maximum of 5 A and the right-most relay 234 can be rated to provide a maximum of 16 A. In some forms, the right-most pump relay terminal block 224 can be electrically coupled to two of the relays 234 while the left-most pump relay terminal block 224 can be electrically coupled to a third one of the relays 234 or vice versa. In this way, a variety of devices can be connected to, powered by, and controlled through, an electrical connection with the relays 234. Each pump relay terminal block 224 includes four terminals, two of which can be electrically coupled to an auxiliary power supply and/or circuit breaker and two of which can be electrically coupled to the relayed auxiliary device(s) 240. Examples of auxiliary devices 240 that can be electrically coupled to the pump relay terminal blocks 224 include, for example, lighting assemblies, salt chlorine generators, water quality monitors, booster pumps, single speed pumps, spa blowers, chlorinators, pool vacuums, water features, fountains, heaters, or other pool accessories and equipment. In some forms, the pump 104 can include a combination of data and power transmission instead of, or in addition to, the relays 234. For example, rather than being coupled to the relays 234, any of the auxiliary devices 240 can be coupled via a wired connection to a control port of the pump 104 that provides power to the auxiliary devices 240 as well as two-way communication. In some forms, all of the data transmission and communication between the pump 104 and the auxiliary devices 240 occurs wirelessly.

The digital input terminals 226 can provide an electrical connection between the pump 104 and a mid-level automation device 242. The digital input terminals 226 can provide a plurality of speed control or flow control terminals, such that the mid-level automation device 242 can cause the pump 104 to run at a plurality of pump speeds, e.g., revolutions per minute (RPM) or volumetric flow rates, e.g., gallons per minute (GPM). In some instances, four or more pump speeds or flow rates can be initiated by the mid-level automation device 242. The main circuit board 200 can be programmed such that when the automation device 202 is electrically connected to the RS-485 terminal block 186, the digital input terminals 226 are ignored. In some forms, when the automation device 202 is electrically connected to the RS-485 terminal block 186, the relays 234 are deactivated such that there can be no pass-through control of the auxiliary devices 240 from the automation device 202. In some forms, pass-through control of the auxiliary devices 240 from the automation device 202 is simply absent, e.g., not a provided functionality. In some forms, however, the automation device 202 can control all aspects of the operation of the pump 104 as well as all aspects of the operation of the auxiliary devices 240, providing pass-through control of auxiliary devices 240 that are connected to the relays 234 from the automation device 202. For example, if a lighting assembly is connected to the pump 104, and the pump 104 is connected to the automation device 202, the automation device 202 can send instructions that will implement lighting assembly logic to turn the lighting assembly on/off, light up in different colors, or provide various animations.

The main circuit board 200 may be provided with one or additional components provided in the form of electronics, software, sensors, actuators, and/or network connectivity to collect and exchange data. In some embodiments, the main circuit board 200 may send and/or receive data transmissions over a local area network (LAN), a wide area network (WAN), and/or another communication network using any suitable communication protocol. For example, the main circuit board 200 may communicate over the LAN with a local server computing device, such as in a private network where transmitted data to/from the main circuit board 200 is isolated from the internet or another WAN, at least until the data is processed by the local server. In some embodiments, (a) local server(s) may be operated at the same location as the pump 104, such as at a residence or business. A user device may also be connected to the LAN in order to access the data; alternatively, IP connectivity may be used, connecting the LAN and/or the local server(s) to the Internet or another WAN, so that local and/or remote user devices can access the local server.

Further, the main circuit board 200 may connect directly or through a router, gateway, base station, etc. (shown as wired/wireless router or gateway), to the WAN in order to communicate with cloud-based computing resources. Such an environment provides a bi-directional, direct-to-cloud communication between the main circuit board 200 and one or more application and/or hosting servers. In some embodiments, the main circuit board 200 may communicate with and directly use the resources of one or more physical, remote server computing devices, which may be deployed in one or more data centers (for example) in a particular geographic location or dispersed throughout several geographic locations. In other embodiments, the remote physical servers may cooperate to provide virtualized computing resources that can be allocated for use by, for example, an authorized user of a computing resource service provider. In various embodiments, the server may be a virtual server or may represent a cluster of servers. In some forms, the server can be confirmed to store and provide data analytics associated with any variety of operational, maintenance, scheduling, or other parameters related to the pump 104 over time, such as flow rates, pump speeds, temperatures, pump power consumption value, e.g., kilowatt-hours over a period of time such as a week, system pressure, the total dynamic head, and total gallons pumped.

Non-limiting examples of communication protocols include: a wired (e.g., CAT5, USB) connection to a router and any TCP/IP protocol for wired connections; a wireless connection to a router, and wireless TCP/IP protocols such as Wi-Fi or MQTT; and/or direct communication with another IoT device using the above wireless protocols or other suitable protocols such as Bluetooth or Wi-Fi direct. More generally, a communication network can include a Wi-Fi network (e.g., an 802.11x network, which can include one or more wireless routers, one or more switches, etc.), a peer-to-peer network (e.g., a Bluetooth network, a ZigBee® network, a Z-Wave® network, a proprietary RF connection, etc.), a cellular network (e.g., a 3G network, a 4G network, a 5G network etc., complying with any suitable standard, such as CDMA, GSM, LTE, LTE Advanced, WiMAX, etc.), a wired network, an EnOcean® network, etc. In some embodiments, the communication network can be a LAN, a WAN, a public network (e.g., the Internet), a private or semi-private network (e.g., a corporate or university intranet), any other suitable type of network, or any suitable combination of networks.

In some embodiments, the antenna 182 is configured to send and/or receive wireless signals, such as signals for communicating over Wi-Fi, Bluetooth, ZigBee, Z-Wave, free-space optical, etc. In some such embodiments, the antenna 182 can receive signals from the wireless gateway module and can transmit the signals to the main circuit board 200 for processing into commands. Additionally, or alternatively, the antenna 182 can send signals generated by the main circuit board 200 to the wireless gateway/router. In some embodiments, the main circuit board 200 can communicate with server(s) and/or other IoT devices in the network using the antenna 182. For example, the antenna 182 can be used to communicate using a direct connection (e.g., over a Bluetooth connection, over a direct Wi-Fi connection such as an ad hoc Wi-Fi connection or Direct Wi-Fi connection), and/or an indirect connection (e.g., over a LAN, over a mesh network, etc.).

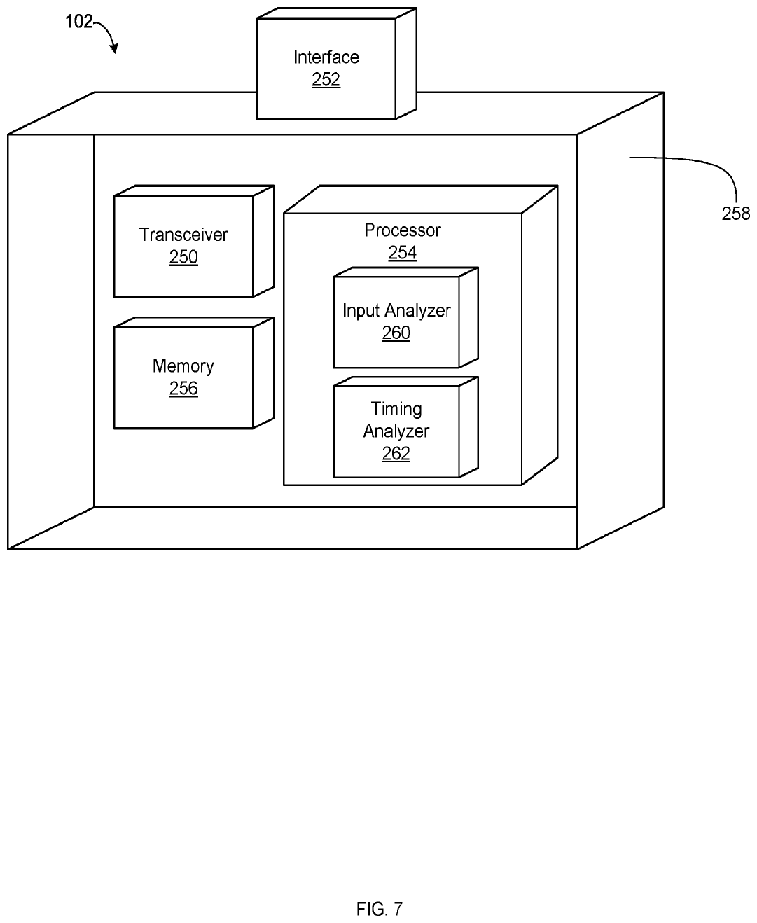

Referring to FIG. 7, a block diagram of the variable speed pumping timer 102 is shown, according to an exemplary embodiment. The variable speed pumping timer 102 includes a housing 258 that supports a transceiver 250, an interface 252, a processor 254, and memory 256. In some embodiments, the transceiver 250, the processor 254, and the memory 256 are retained within and thus protected by the housing 258. In some embodiments, the interface 252 is externally supported by the housing 258 and thus accessible to the user 110 (see FIG. 1).

In some embodiments, the user 110 (see FIG. 1) provides the input by pressing a button on the interface 252. In certain embodiments, the button may be a “hard” button, i.e., a physical button, but in certain other embodiments, the button may be a “soft” button, i.e., a button displayed on a graphical user interface (GUI). In another embodiment, the user 110 provides the input by rotating a knob of the variable speed pumping timer 102. Further, the interface 252 communicates the input provided by the user 110 to the processor 254.

Additionally, the memory 256 is configured to store inputs of an operational time periods for each device 108A-108E entered by the user 110 via the pump 104 (see FIG. 1) and/or the variable speed pumping timer 102. The processor 254 is configured to retrieve information from the memory 256. The processor 254 is communicably coupled with the transceiver 250, the interface 252, and the memory 256.

The processor 254 includes an input analyzer 260 and a timing analyzer 262. The input analyzer 260 is configured to identify and correspond inputs supplied by the user 110 with respective devices 108A-108E based on the inputs. The timing analyzer 262 is configured to schedule, monitor, and operate (e.g., turn on and off) the one or more devices 108A-108E according to the inputs provided by the user 110. The processor 254 is further configured to communicate with the transceiver 250 to transmit control signals to operate the devices 108A-108E. In some embodiments, the control signals are transmitted to the pump 104 (see FIG. 1). Thus, each of the devices 108A-E are respectively operated for various time periods based on the inputs provided by the user 110.

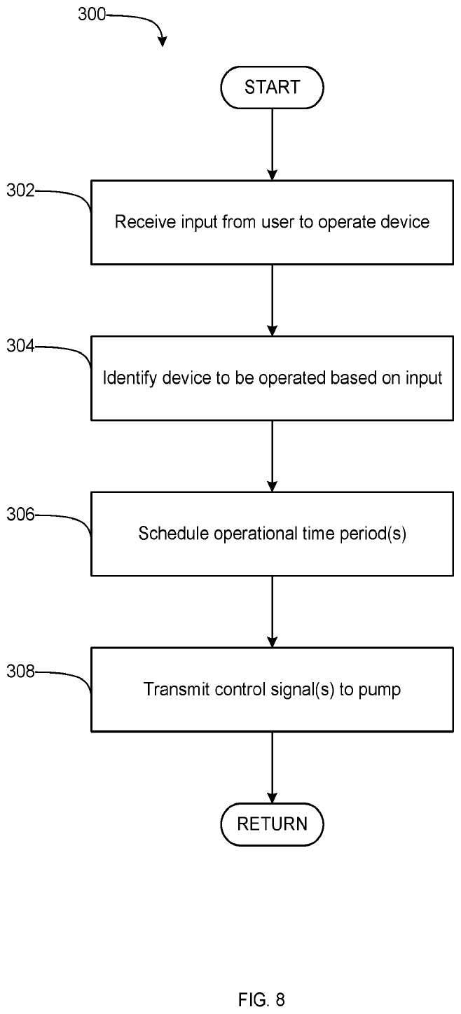

Referring to FIG. 8, a flow chart showing a first method 300 for operating one or more devices (e.g., devices 108A-E) by a variable speed pumping timer (e.g., the variable speed pumping timer 102) is shown. The method 300 starts at block 302, where, using the interface 252, the variable speed pumping timer 102 receives input from the user 110 to operate one or more of the devices 108A-E. The method 300 proceeds to block 304.

At block 304, using the input analyzer 260, the variable speed pumping timer 102 identifies the devices 108A-E to be operated based on the inputs. The method 300 proceeds to block 306.

At block 306, using the timing analyzer 262, the variable speed pumping timer 102 schedules one or more operational time periods for which the devices 108A-108E are to be operated based on the inputs. The method proceeds to block 308.

At block 308, using the transceiver 250, the variable speed pumping timer 102, transmits one or more control signals to the pump 104 to operate (e.g., turn on and off) the one or more devices 108A-108E based on the inputs. To be functional and operational, the variable speed pumping timer 102 and the pump 104 draw power from the power source 106. To be functional and operational, the devices 108A-E draw power from the pump 104. The method 300 returns to block 302.

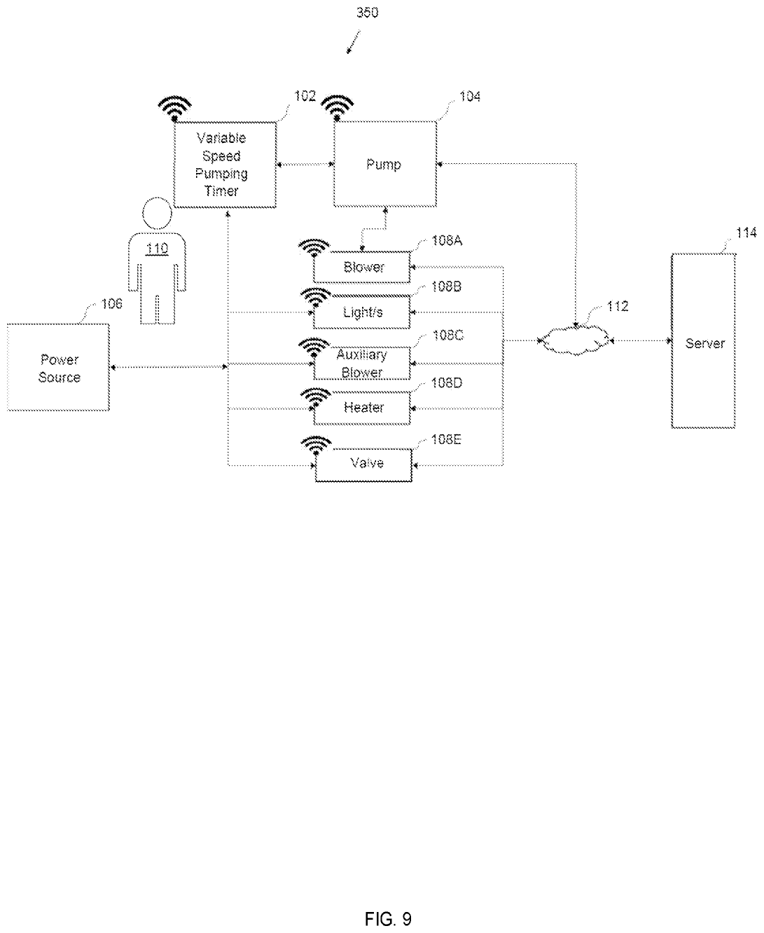

Referring to FIG. 9, a second system architecture 350 is shown. The second system architecture 350 includes the variable speed pumping timer 102, the pump 104, the power source 106, the devices 108A-108E, the user 110, the network 112, and the server 114 described above. In the second system architecture 350, the variable speed pumping timer 102 receives power from and communicates with the pump 104 and the power source 106. Additionally, the devices 108A-108E variously draw power from the power source 106 and/or from the pump 104. The devices 108A-108E variously communicate with the variable speed pumping timer 102 directly and/or via the pump 104. Further, the pump 104 and the devices 108A-E are connected to and communicate with the server 114 via the network 112. Thus, the variable pumping timer 102 is indirectly connected to and communicates with the server 114 via the pump 104 and the network 112.

In some instances, when the user 110 provides inputs to the variable speed pumping timer 102 to operate a first one of the devices 108A-E, the variable speed pumping timer 102 identifies a second of the devices 108A-E to be operated simultaneously with the first device (e.g., auxiliary blower 108C). More specifically, the variable speed pumping timer 102 activates logic to determine whether any other of the device(s) 108A-E connected with the pump 104 and the variable speed pumping timer 102 are to be correspondingly operated along with the first one of the devices 108A-E as chosen by the user 110. For example, if the auxiliary blower 108C is chosen by the user 110 to be operated, then the variable speed pumping timer 102 automatically operates the lights 108B along with the auxiliary blower 108C. Thus, in some instances, corresponding ones of the devices 108A-E are operated together for the same time period.

In some instances, the variable speed pumping timer 102 transmits control signals to the pump 104 to operate the one of more of the devices 108A-E. In some instances, the variable speed pumping timer 102 directly transmits control signals to one or more of the devices 108A-E. Such control signals are transmitted by the variable speed pumping timer 102 through a wired connection and/or a wireless connection.

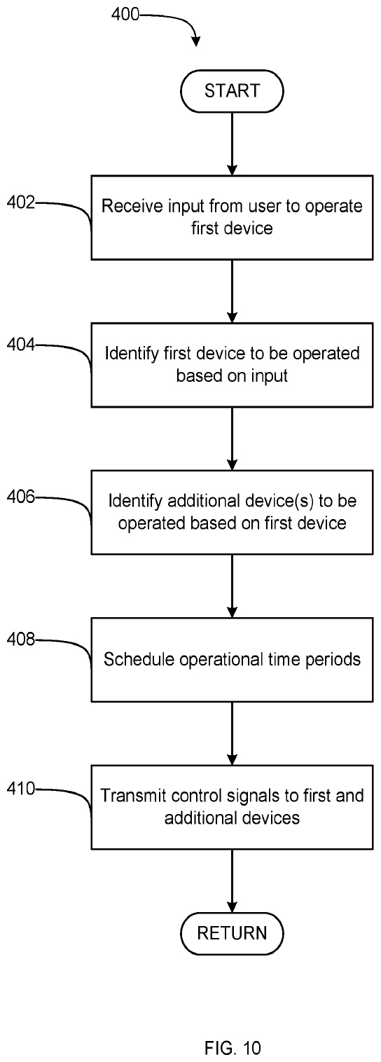

Referring to FIG. 10, a flow chart showing a second method 400 for operating devices (e.g., devices 108A-E) by a variable speed pumping timer (e.g., the variable speed pumping timer 102) is shown. The method 400 starts at block 402, where, using the interface 252, the variable speed pumping timer 102 receives an input from the user 110 to operate a first device (e.g., blower 108A). The method 400 proceeds to block 404.

At block 404, using the input analyzer 260, the variable speed pumping timer 102 identifies the first device (e.g., blower 108A) to be operated based on the input. The method 400 proceeds to block 406.

At block 406, using the input analyzer 260, the variable speed pumping timer 102 identifies additional devices (e.g., lights 108B and heater 108D) to be operated based on the first device (e.g., blower 108A). In other words, the variable speed pumping timer 102 determines and selects additional devices that are intended to be operated alongside and/or simultaneously with the first device. Thus, the variable speed pumping timer 102 identifies additional devices corresponding to the first device. The method 400 proceeds to block 406.

At block 408, using the timing analyzer 262, the variable speed pumping timer 102 schedules a first operational time period for which the first device (e.g., blower 108A) is to be operated based on the input and additional operational time periods for which the additional devices (e.g., lights 108B and heater 108D) are to be operated based on the first device. The method proceeds to block 410.

At block 410, using the transceiver 250, the variable speed pumping timer 102 transmits control signals to the first device and the additional devices. The control signals are sent to the first device and to the additional devices directly and/or via the pump 104. To be functional and operational, the variable speed pumping timer 102 and the pump 104 draw power from the power source 106. To be functional and operational, the devices 108A-E draw power from the pump 104. The method 400 returns to block 402.

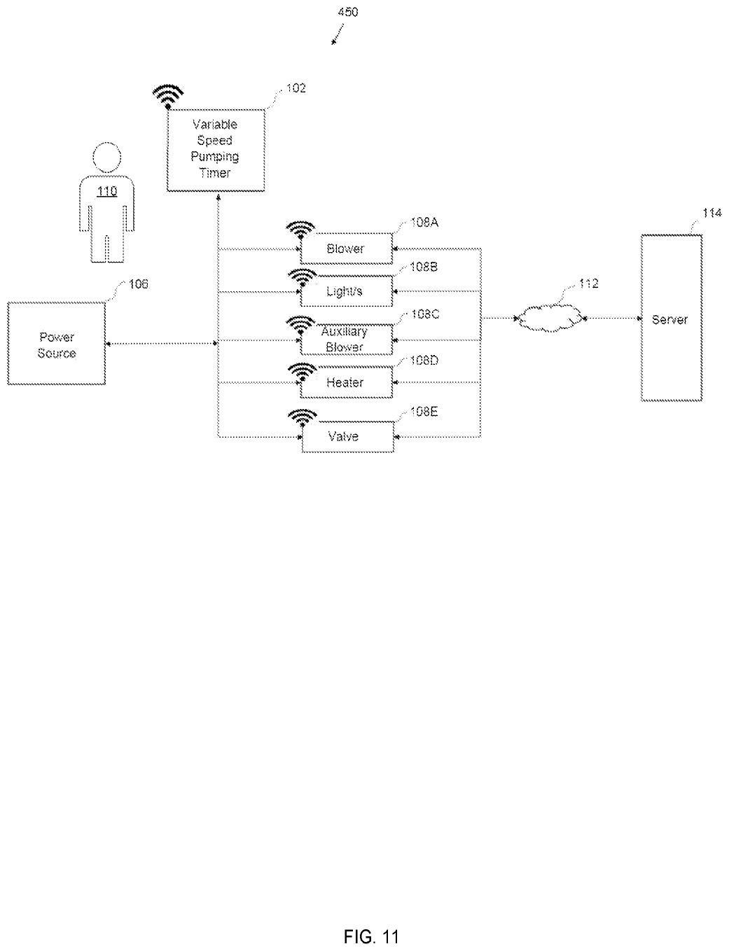

Referring now to FIG. 11, a third system architecture 450 is shown. The third system architecture 450 includes the variable speed pumping timer 102, the power source 106, the devices 108A-108E, the user 110, the network 112, and the server 114. The variable speed pumping timer 102 communicates with and receives power from the power source 106. The variable speed pumping timer 102 additionally communicates with the devices 108A-E. Further, the devices 108A-108E communicate with and receive power from the power source 106.

When the user 110 provides inputs to the variable speed pumping timer 102, the variable speed pumping timer 102 receives the inputs and directly transmits control signals to one or more of the devices 108A-E to operate the devices 108A-E based on the inputs. In some instances, the variable speed pumping timer 102 operates two or more of the devices 108A-E simultaneously based on the inputs. The control signals are transmitted by the variable speed pumping timer 102 to the devices 108A-E via a wired connection and/or a wireless connection.

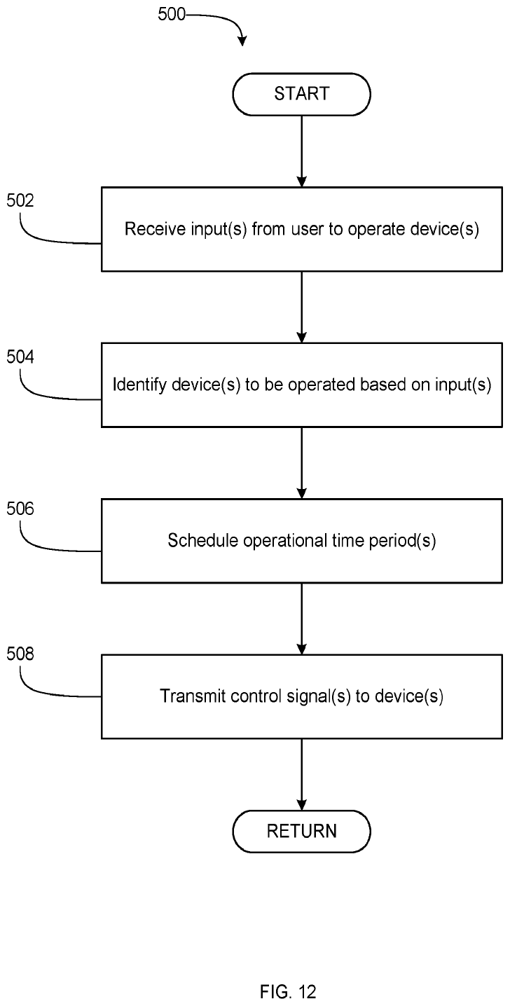

Referring to FIG. 12, a flow chart of a third method 500 for operating devices (e.g., the devices 108A-E) by a variable speed pumping timer (e.g., the variable speed pumping timer 102) is shown. The third method 500 starts at block 502, where, using the interface 252, the variable speed pumping timer 102 receives input from the user 110 to operate one or more of the devices 108A-E. The method 500 proceeds to block 504.

At block 504, using the input analyzer 260, the variable speed pumping timer 102 identifies the devices 108A-E to be operated based on the inputs. The method 500 proceeds to block 506.

At block 506, using the timing analyzer 262, the variable speed pumping timer 102 schedules one or more operational time periods for which the devices 108A-108E are to be operated based on the inputs. The method proceeds to block 508.

At block 508, using the transceiver 250, the variable speed pumping timer 102, transmits control signals to the one or more devices 108A-E to operate (e.g., turn on and off) the one or more devices 108A-108E based on the inputs. To be functional and operational, the variable speed pumping timer 102 and the devices 108A-E draw power from the power source 106. The method 500 returns to block 502.

The present disclosure offers the following technical advantages over the existing prior art: a) eliminates the use of a high voltage relay or a contactor to connect a pump and electrical device/s with a power source; b) enables the pump and the electrical device/s to remain connected with the power source even after the pump or a variable speed pumping timer stops operating a device, c) enables the pump and the electrical device/s to receive information from a server since the pump and the electrical device/s remain connected with the power source even after the pump or the variable speed pumping timer stops operating the device, d) reduces the bulk of the device/s since the device/s no longer has to switch high voltage power as the pump and the electrical device/s do not need to be disconnected from the power source, e) protects the pump motor control from having to go through unnecessary power cycles every day of its lifetime as the pump and the electrical device/s do not need to be disconnected from the power source.

It will be appreciated by those skilled in the art that while the disclosure has been described above in connection with particular embodiments and examples, the disclosure is not necessarily so limited, and that numerous other embodiments, examples, uses, modifications and departures from the embodiments, examples, and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A variable speed pump system for an aquatic system, comprising:
a variable speed pumping timer having an interface to receive an input from a user to operate one or more aquatic devices and to transmit a control signal based on the input received from the user;
a power source in communication with the pumping timer; and
a pump in communication with the variable speed pumping timer and the power source, the pump designed to receive the control signal from the variable speed pumping timer and to operate the one or more devices based on the control signal.

2. The system of claim 1, wherein the pump is further configured to receive information from a server through a network after operating the one or more devices.

3. The system of claim 2, wherein the information received from the network corresponds to an update related to the one or more devices.

4. The system of claim 1, wherein the input from the user corresponds to a time period for operating the one or more devices.

5. The system of claim 4, wherein the one or more devices are operated for the time period and a signal is sent to the one or more devices that corresponds to the time period.

6. The system of claim 1, wherein the one or more devices include an auxiliary blower, a blower, one or more lights, a brush, a scrubber, a valve, or a heater.

7. The system of claim 1, wherein the control signal corresponds to one or more of a wireless signal or a wired signal.

8. The system of claim 1, wherein the pump is provided in the form of a variable speed pump.

9. The system of claim 1, wherein at least two of the variable speed pumping timer, the pump, or the one or more devices are Wi-Fi enabled.

10. The system of claim 1, wherein at least two of the variable speed pumping timer, the pump, or the one or more devices are connected through a wired connection.

11. A pump system for a pool or spa, comprising:
a power source;
a pump in communication with and powered by the power source;
a first device connected to and powered by the pump; and
a second device connected to and powered by the power source; and
a variable speed pumping timer configured to:
receive an input from a user to operate the first device,
transmit a first control signal to the pump for operating the first device based on the input received from the user, and
identify the second device and transmit a second control signal to the second device to operate the second device based on the first device, wherein the pump remains connected to the power source after operating the first device, and the second device remains connected to the power source after the second device is operated by the variable speed pumping timer.

12. The system of claim 11, wherein the pump is further configured to receive information from a network after operating the first device, and the second device is further configured to receive information from the network after the second device is operated by the variable speed pumping timer.

13. The system of claim 11, wherein the variable speed pumping timer is further configured to identify the first device based on the input.

14. The system of claim 11, wherein the second device is operated simultaneously with the first device.

15. The system of claim 11, wherein the variable speed pumping timer transmits the first control signal and the second control signal via one or more of a wired connection or a wireless connection.

16. The system of claim 11, wherein the variable speeding pumping timer is powered by the power source.

17. The system of claim 16, wherein the variable speed pumping timer remains connected to the power source after operating the second device.

18. A variable speed pumping timer, comprising:
a housing in communication with an interface configured to receive an input from a user to operate one or more devices; and
a transceiver configured to transmit a control signal to operate the one or more devices based on the input received from the user, wherein each of the one or more devices is connected to a power source and remains connected to the power source after the one or more devices are operated.

19. The variable speed pumping timer of claim 18, wherein the one or more devices is further configured to receive information from a network after the one or more devices is operated by the variable speed pumping timer.

20. The variable speed pumping timer of claim 18, further including a processor configured to:
identify a first device based on the input received from the user, and
identify a second device based on the first device.
